(19) United States
(12) Patent Application Publication
(10) Pub. No.: US 2007/0005902 A1
(43) Pub. Date: Jan. 4, 2007

(54) INTEGRATED SRAM CACHE FOR A MEMORY MODULE AND METHOD THEREFOR

(75) Inventors: Ryan M. Petersen, Sunnyvale, CA (US); Franz Michael Schuette, Colorado Springs, CO (US)

Correspondence Address: HARTMAN & HARTMAN, P.C., 552 EAST 700 NORTH, VALPARAISO, IN, 46383, US

(73) Assignee: OCZ TECHNOLOGY GROUP, INC., Sunnyvale, CA (US)

(21) Appl. No.: 11/164,838

(22) Filed: Dec. 7, 2005

Related U.S. Application Data
(60) Provisional application No. 60/593,075, filed on Dec. 7, 2004.

(51) Int. Cl. G06F 12/00; G06F 13/00

(52) U.S. Cl. 711/137; 711/104

(57) ABSTRACT

A memory module having at least one random access memory device and a memory bus on a substrate. The memory module further comprises an SRAM cache interfaced with the random access memory device through an ASIC associated with the SRAM cache and operable as a prefetch controller for the SRAM cache. The ASIC and SRAM cache cooperate to enable data to be prefetched and cached during idle cycles of the memory device, thereby increasing the overall operating speed of the memory circuit by minimizing latencies should the prefetched data be requested. The ASIC can be programmed to prefetch not only data from the originally accessed row during a read operation, but also to speculatively prefetch data from logically coherent rows in order to anticipate and counteract a page miss and the associated latencies based on the locality of data.

### CROSS REFERENCE TO RELATED APPLICATIONS

This application claims the benefit of U.S. Provisional Application No. 60/593,075, filed Dec. 7, 2004, the contents of which are incorporated herein by reference.

### BACKGROUND OF THE INVENTION

The present invention generally relates to memory subsystems for computers and other electronic consumer products. More particularly, this invention relates to a memory module made up of DRAM chips and equipped with an SRAM cache interfaced with the DRAM through its own ASIC (application specific integrated circuit).

Conventional DRAM (dynamic random access memory) including SDRAM (synchronous dynamic random access memory) receives its address command in two address words using a time multiplexed addressing scheme. Briefly, after a row address is selected by a row address strobe (RAS), the data have to be sensed by the sense amplifiers of each row before a column address can be selected by the column address strobe (CAS). Subsequently, the moving of data from the sense amplifiers to the output buffers incurs the so-called Read or CAS latency.

It is understood that the time multiplexing of addresses in DRAM technology limits the performance of the memory subsystem because each data access requires two distinct addressing steps with their inherent latencies. Modern DRAM technology, therefore, has introduced the paged mode, which means that after a row address is given and the row or page is opened, several read commands can be issued to retrieve data from within this page. The access of data within a page, however, requires that the respective page is kept open throughout the entire duration of all reads. If the requested data exceed the contents of a page or, in DRAM parlance, cross a page boundary, the original page needs to be closed before the next page can be opened. The same is true if a read command specifies an address that is not found within a currently open page, this is called a page miss and also requires closing of the current page in order to open the one containing the requested data. On the other hand, the paged mode allows a simple bursting scheme in that a single column address is issued along with the number of desired consecutive transactions, known as burst length, and the control logic inside the DRAM device will generate the subsequent column addresses to sustain the Read process resulting in a bursting of data onto the bus.

The architecture outlined in principle above has the advantage of being very cost effective on both the memory component manufacturing level as well as on the level of implementation on the mainboard. The multiplexed address bus for DRAM components uses the same pins for row and column addressing and, therefore, allows a low pin count design. On the level of the memory die design, the relatively simple architecture of a non-cached memory array with a simple address generating unit for burst mode and a standard I/O logic has been optimized through several design generations for an optimal price performance compromise.

Several issues with the existing DRAM design and architecture have recently attracted attention. One particular issue is that within each bank, only a single row or page of memory can be held open at any time. As mentioned above, any page miss will incur the penalty of having to precharge the row before another page can be opened. On the other hand, closing the page includes disconnecting the wordlines and shorting the bitlines to restore the precharged state necessary in order to subsequently receive charges, which means that all transactions from the respective page to the I/O portion of the device must have been completed. This is an important performance factor because the size of each page is limited and, consequently, only a limited number of page hits will fall into this page and there can only be a limited number of page hits before the page boundary is hit.

Another problem that recently emerged relates to the large cache size of current central processing units (CPU's) that are able to retain sizeable amounts of data for faster access by the CPU itself. A drawback in such a case is that the operations using cached data can exceed the time interval allowed between the refreshes that are necessary for data retention on DRAM devices. Therefore, attempts to revisit the page will find it closed or, in the worst case scenario, in the process of precharge. Either way, the access latencies will be equivalent or worse than those incurred in the case of a random access.

An additional issue with the current SDRAM architecture is that the voltage swing on the sender and receiver end, as well as along the bus, must be identical. This, by itself, poses a severe limitation in the possible frequency range of the bus interface. Especially in the case of future serial interconnects, the voltage swing could be almost orders of magnitude lower on the bus and the chipset than on the memory devices. This, however, is only possible if at least one buffer is interposed between the memory device and the bus to the chipset or memory controller itself.

All of the above mentioned drawbacks of the existing architectures underscore the necessity for more advanced solutions.

Cached memory architectures are well known to those skilled in the art and have involved direct mapping of entire rows or 4-way set associative integrated SRAM caches on the level of the memory devices. An alternative approach is a Level 3 cache on the level of the memory controller. Yet another approach is buffering of addresses and commands on the level of memory modules mostly for purposes of electrical separation of chipset and memory signaling voltages.

### BRIEF SUMMARY OF THE INVENTION

The present invention provides a memory module having at least one random access memory device (such as DRAM) and a memory bus on a substrate. The memory module further comprises an SRAM cache interfaced with the random access memory device through an ASIC associated with the SRAM cache and operable as a prefetch controller for the SRAM cache. The ASIC and SRAM cache cooperate to enable data to be prefetched and cached during idle cycles of the memory device, thereby increasing the overall operating speed of the memory circuit by minimizing latencies should the prefetched data be requested by the CPU. In addition, the SRAM cache can buffer modified cache lines from the CPU to make those data available immediately after writing them out to the memory module without a need to satisfy the write recovery time and finally write those data to the DRAM devices during the next idle cycles of the memory bus. The ASIC can be programmed to prefetch not only data from the originally accessed row during a read operation, but also to speculatively prefetch data from logically coherent rows in order to anticipate and counteract a page miss and the associated latencies based on the locality of data. The SRAM cache also allows porting to the bus of the memory module in a format other than a 64-bit memory bus, and enables signal independence from the supply voltage of the memory device.

In view of the above, an advantage of the present invention is better management of data stored in memory through an on-module cache without the footprint limitations of prefetch buffers integrated in the chipset/memory controller. In addition, through temporary caching of data, access to a previous but expired page can be done without incurring latencies. The invention also enables electrical isolation of different signaling protocols to enable interfacing of, for example, a high-voltage, low-speed wide data bus with a low-voltage, high-speed narrow bus. Still another advantage is that write operations to memory can be temporarily cached and executed during idle periods.

Other objects and advantages of this invention will be better appreciated from the following detailed description.

### BRIEF DESCRIPTION OF THE DRAWINGS

FIGS. 1 and 2 schematically represent two embodiments of memory modules equipped with a prefetch controller and an SRAM cache in accordance with the present invention.

FIG. 3 is a flow chart comparing read operations performed with DRAM of a conventional memory module and DRAM of a memory module equipped with SRAM cache in accordance with an embodiment of the present invention.

FIGS. 4 and 5 schematically represent bus interfacing schemes employing a full duplex memory bus and in which the SRAM cache of this invention is implemented as a dual-ported SRAM cache.

### DETAILED DESCRIPTION OF THE INVENTION

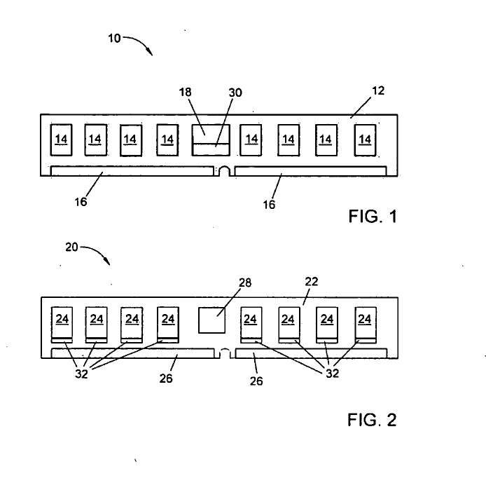

FIGS. 1 and 2 depict memory modules 10 and 20 configured in a conventional manner to plug into an available memory slot (socket) of a computer memory subsystem (not shown), as is well known in the art. As such, each module 10 and 20 comprises a substrate 12/22, on which is mounted a number of random access memory devices 14/24, such as DRAM, SDR SDRAM, or DDR SDRAM chips. In practice, the substrate 12/22 is typically in the form of a printed circuit board (PCB), though other types of substrates are also within the scope of this invention. To provide the electrical connection between each module 10/20 and its memory slot, the modules 10 and 20 include edge connectors 16 and 26 along an edge of their respective substrates 12 and 22, by which digital signals (command, address, and data) are transmitted to and from the devices 14 and 24 through input/output (I/O) pins. As known in the art, the edge connectors 16 and 26 can be configured such that the modules 10 and 20 are a single in-line memory module (SIMM) or a dual in-line memory module (DIMM).

As represented in FIG. 1, the first embodiment of the current invention makes use of an ASIC (application specific integrated circuit) chip 18 programmed to include the capability of operating as a prefetch controller for SRAM cache 30 integrated onto the ASIC chip 18. The ASIC chip 18 and its integrated SRAM cache 30 are attached to the substrate 12 as a single, separate chip. In the second embodiment of the invention represented in FIG. 2, an ASIC chip 28 is represented as being individually attached to the substrate 22, while SRAM cache 32 is up-integrated onto each of the memory devices 24 of the module 20. Each SRAM cache 30 and 32 is interfaced with its corresponding memory devices 14 and 24 through its associated ASIC chip 18 or 28. From the foregoing, each SRAM cache 30 and 32 provides a port to the memory bus (not shown) of its memory modules 10 or 20, and allows porting to the memory bus in a format other than a 64-bit memory bus. The physical location of the SRAM cache 30 and 32 between the bus and memory devices 14 and 24 also enables the memory devices 14 and 24 to have signal independence from the supply voltage on the modules 10 and 20.

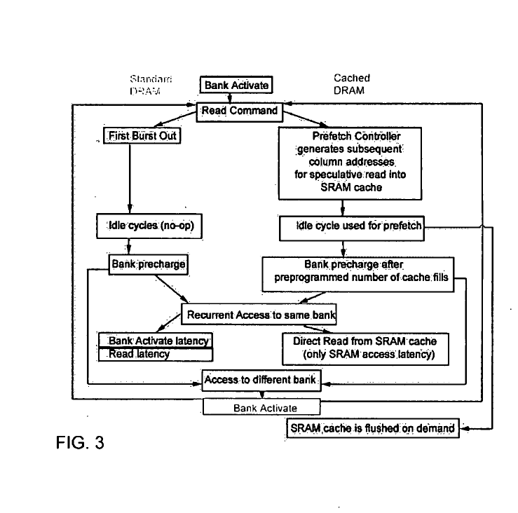

With each of the above configurations, and SRAM cache 30/32 and the prefetch control capability provided by its ASIC 18/28 cooperate to enable data to be prefetched and cached during idle cycles of the memory devices 14/24, thereby increasing the overall operating speed of the memory circuit by minimizing latencies should the prefetched data be requested by the CPU. The ASIC 18/28 can be programmed to prefetch not only data from the originally accessed row during a read operation, but also to speculatively prefetch data from logically coherent rows in order to anticipate and counteract a page miss and the associated latencies based on the locality of data. This aspect of the invention is illustrated in FIG. 3, which is a flow chart comparing read operations performed with DRAM of a conventional memory module (“Standard DRAM”) and DRAM of one of the memory modules 10 or 20 equipped with SRAM cache 30 or 32 (“Cached DRAM”) in accordance with the invention. Bank activation of DRAM memory cells and issuance of a read operation by supplying the column address along with the necessary commands to the activated bank can be the same for both memory systems. In the case of the SRAM cache of the Cached DRAM, the row and column addresses need to be demultiplexed and split over separate address lines for rows and columns. However, this can be done locally on the printed circuit board and does not incur expensive real estate for additional traces on the motherboard.

During a first burst mode followed by idle cycles occurring in the Standard DRAM, the ASIC chip 18/28 associated with the SRAM cache 30/32 of the Cached DRAM generates subsequent column addresses for speculative read operations into the SRAM cache 30/32, followed by a prefetch operation during the idle cycles of the Standard DRAM. Following bank precharge, a different bank may be accessed or recurrent access to the same bank may occur, depending on circumstances. If the action is a recurrent access to the same bank, bank activate and read latencies are encountered by the Standard DRAM, while in contrast a direct read from the SRAM cache 30/32 is possible with the Cached DRAM of this invention, with only SRAM access latency being encountered. Because SRAM access latency is significantly shorter than cumulative bank activate and read latencies, read operations carried out by the Cached DRAM of this invention can be notably faster than those possible with the Standard DRAM.

In view of the above, the on-module SRAM cache 30 and 32 of this invention offer better management of data stored in the memory devices 14 and 24 through temporary caching of data during idle periods, which enables access to a previous page without incurring latencies. Write operations to the memory devices 14 and 24 may also be temporarily cached and executed during idle periods. Another advantage of the invention is the ability to electrically isolate different signaling protocols to enable interfacing of, for example, a high-voltage, low-speed wide data bus with a low-voltage, high-speed narrow bus.

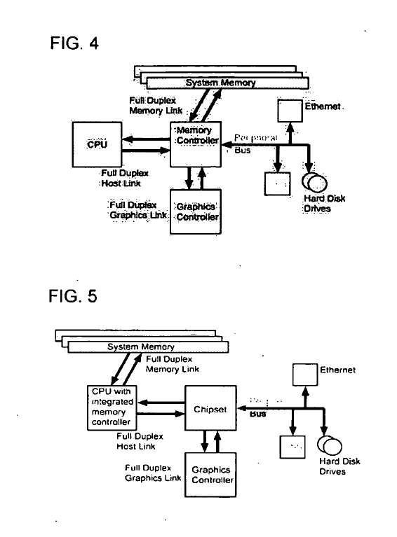

A potential limitation of the invention as described above is that the global I/O of the DRAM is the limiting bandwidth factor, that is, only one bit per data rate can be transferred to the SRAM. However, the present invention provides the potential for performance gains, particularly in write operations that can be buffered in the SRAM cache and executed on a buffer flush point or else during idle periods. This aspect of the invention has the potential of becoming particularly important if a full duplex memory bus is implemented because it will allow interspersed write commands within a read sequence. Accordingly, an optional aspect of the invention is the use of a dual-ported SRAM cache. These aspects of the bus interfacing may become very important in future system memory architectures using high-speed narrow or serial buses, as illustrated in FIGS. 4 and 5. In FIG. 4, the memory controller is on the chipset, while in FIG. 5 the memory controller is integrated into the CPU.

While the invention has been described in terms of a preferred embodiment, it is apparent that other forms could be adopted by one skilled in the art. For example, the physical configuration of the memory modules could differ from that shown, and random access memory devices other than that noted could be used. Therefore, the scope of the invention is to be limited only by the following claims.

What is claimed is:

1. A memory module comprising at least one random access memory device and a memory bus on a substrate, the memory module comprising an SRAM cache interfaced with the random access memory device through an ASIC associated with the SRAM cache and operable as a prefetch controller for the SRAM cache.

2. The memory module according to claim 1, wherein the ASIC is operable to prefetch data into the SRAM cache during an idle period following a page access so that the prefetched data are accessible with minimal latencies.

3. The memory module according to claim 2, wherein the SRAM cache buffers cache lines from a CPU in communication with the memory module.

4. The memory module according to claim 1, wherein the ASIC is programmed to prefetch data from a first accessed row and also speculatively prefetch data from at least one logically coherent row of the first accessed row.

5. The memory module according to claim 1, wherein the random access memory device is a DRAM device.

6. The memory module according to claim 1, wherein the SRAM cache is configured for porting to the memory bus in a format other than a 64-bit memory bus.

7. The memory module according to claim 1, wherein the SRAM cache is configured so that command signals at the random access memory device are independent from a supply voltage signal supplied to the random access memory device through the memory bus.

8. The memory module according to claim 1, wherein the memory bus is a full duplex memory bus that allows interspersed write commands within a read sequence of the random access memory device.

9. The memory module according to claim 8, wherein the SRAM cache is a dual-ported SRAM cache.

10. A process of accessing data from at least one random access memory device of a memory module, the process comprising:
activating a bank of memory cells of the random access memory device;
issuing a read command comprising row and column address select commands to the bank of memory cells;
during an idle cycle following the read command, performing a prefetch operation to prefetch data into a SRAM cache so that the prefetched data are accessible with minimal latencies; and
direct reading from the SRAM cache in response to a second read command.

11. The process according to claim 10, wherein the prefetched data comprises data from a first accessed row of the random access memory device and also speculatively prefetched data from at least one logically coherent row of the first accessed row.

12. The process according to claim 10, further comprising using the SRAM cache to buffer cache lines from a CPU in communication with the memory module.

13. The process according to claim 10, wherein the random access memory device is a DRAM device.

14. The process according to claim 10, wherein the SRAM cache ports to a memory bus of the memory module in a format other than a 64-bit memory bus.

15. The process according to claim 10, wherein the SRAM cache is configured so that command signals at the random access memory device are independent from a supply voltage signal supplied to the random access memory device through a memory bus of the memory module.

16. The process according to claim 10, wherein the memory module comprises a full duplex memory bus and interspersed write commands occur within a read sequence of the random access memory device.

17. The process according to claim 16, wherein the SRAM cache is a dual-ported SRAM cache.
